(19) United States
(12) Patent Application Publication
(10) Pub. No.: US 2016/0253971 A1
(43) Pub. Date: Sep. 1, 2016

(54) DYNAMIC VISOR

(71) Applicant: Daniel Robert Shepard, North Hampton, NH (US)

(72) Inventor: Daniel Robert Shepard, North Hampton, NH (US)

(21) Appl. No.: 14/634,892

(22) Filed: Mar. 1, 2015

(51) Int. Cl. G09G 3/36; G06K 9/00

(52) U.S. Cl. CPC G09G 3/3607; G06K 9/00268; G09G 2340/0471; G09G 2340/0478; G09G 2340/045; G09G 2360/14; G09G 2320/0626

(57) ABSTRACT

The present invention is a dynamically adjusting visor that adjusts to block bright light sources without blocking other areas of the user's view. The present invention is a transparent display and an image sensor whereby the sensor detects one or more bright light sources and darkens one or more areas of the transparent display corresponding to those bright light sources. Inputs enable a user to adjust the location and size of the dark areas on the display to align the dark areas with the light sources and the user's eyes.

### CROSS REFERENCE TO RELATED APPLICATIONS

This application claims priority to U.S. Provisional Patent Application No. 61/946,837 titled “DYNAMIC VISOR” that was filed on Mar. 2, 2014 and that application is incorporated herein in its entirety by reference.

### FIELD OF THE INVENTION

The present invention relates to the sun visors, and more particularly to visors that adjust to block bright light sources.

### SUMMARY OF THE INVENTION

Sun visors are a valuable automotive addition to aid a driver when driving into the sun or at night when driving towards oncoming headlights (see FIG. 1). This is particularly true in early morning (when driving eastward) and in the evening (when driving westward). However, traditional visors block a significant portion of a driver's view (see FIG. 2). Some solutions have proposed a tinted visor, but these do not fully block the sun and they reduce the light from other parts of the driver's view, potentially making those other parts of the view from being well seen.

The present invention is a new type of sun visor that solves the above problems. Furthermore, because the present invention does not in any way obscure other parts of the driver's view, the present invention can be used, not only to block the sun, but also at night to block the bright headlights of oncoming cars. The present invention can be used to block one or more bright light sources without obscuring other areas of view (see FIG. 3).

### BRIEF DESCRIPTION OF THE DRAWINGS

FIG. 1 depicts a view for a car driver with oncoming traffic.

FIG. 2 depicts a view using a traditional visor.

FIG. 3 depicts a view using a visor according to the present invention.

FIG. 4 depicts a generalized schematic diagram of an inverting threshold comparator video circuit according to an embodiment of the present invention.

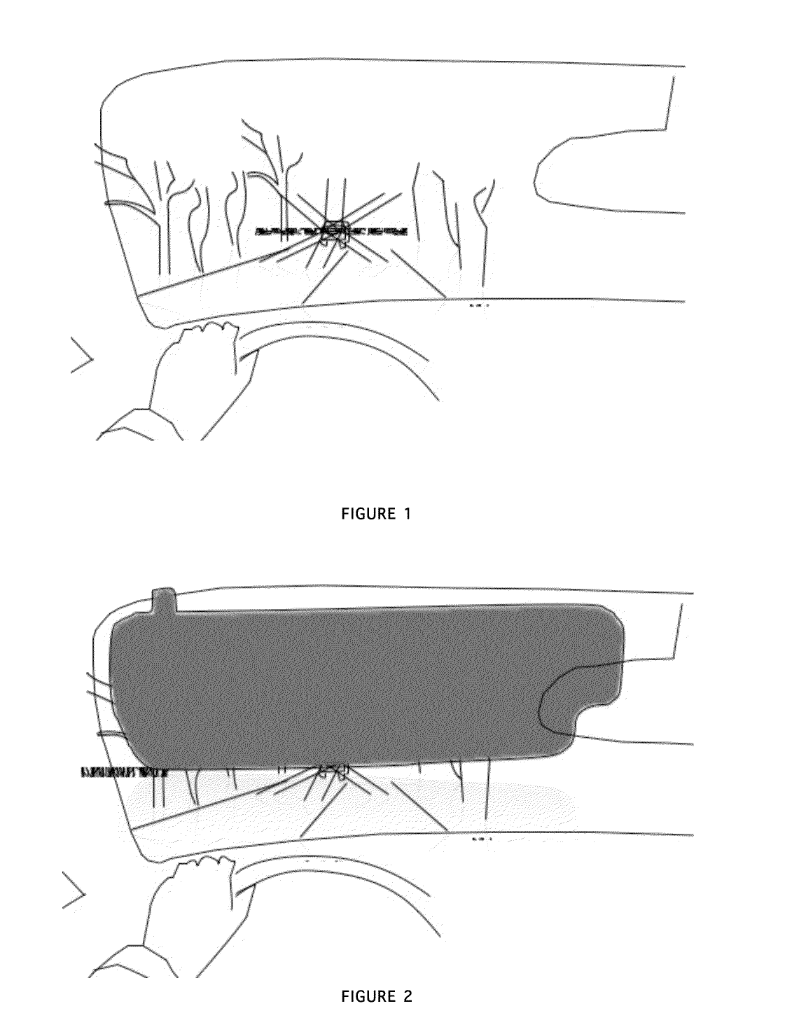

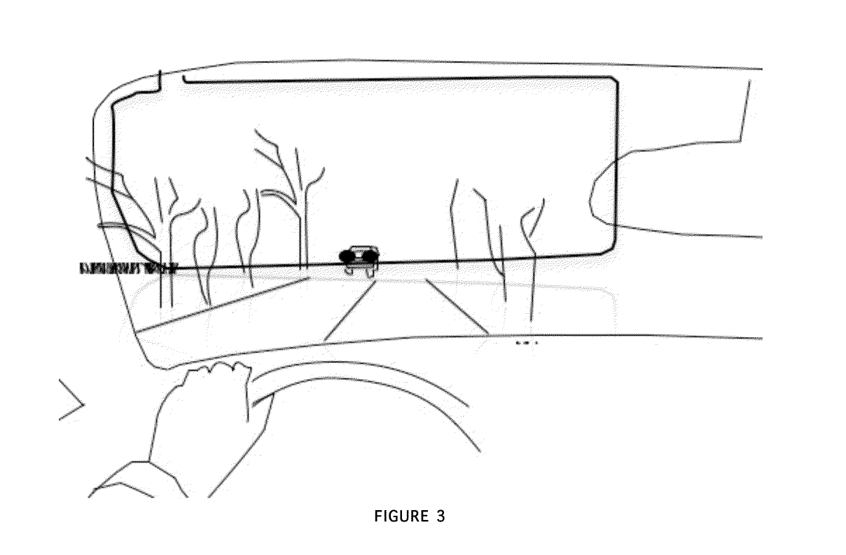

### DESCRIPTION OF THE PREFERRED EMBODIMENT

The present invention is a means to block one or more light sources that can make vision difficult. The present invention allows light to pass in areas of view that are not a bright light source.

The present invention consists of an active screen, such as an LCD, in which areas of the screen (such as pixels of varying size and shape) can be electrically switched between transparent and opaque. The input to the screen is standard composite video, but can be any other input format (analog, NTSC, PAL, digital, etc.) as well however, the screen will have no backlight nor will it have a back cover; during normal operation the screen will be transparent with, typically, only a few areas darkened and not transparent. The screen can be made into the shape of a traditional car visor for easy adaptation by the automotive industry. This visor comprises an array of pixels, each pixel typically containing a liquid crystal layer that has the property of becoming opaque when voltage is applied and being transparent when no voltage is applied (the opposite could be implemented, but this approach incorporates additional safety in case of electrical failure). However, this array of pixels is not limited to an automotive visor form. For example, the array of pixels could be built into the windshield or windscreen of a vehicle such as a car (or a boat or an airplane or a motorcycle or a snowmobile). Another form of the present invention would be to apply the pixel array to a mirror (such as a car rearview mirror) or to have eyeglasses where each eye sees through a pixel array lens. Furthermore, use in a vehicle or an airplane can also provide protection from mischievous use of laser pointers. Driver electronics would either be mounted along the edge or at one end or in an electronics box separate from the display.

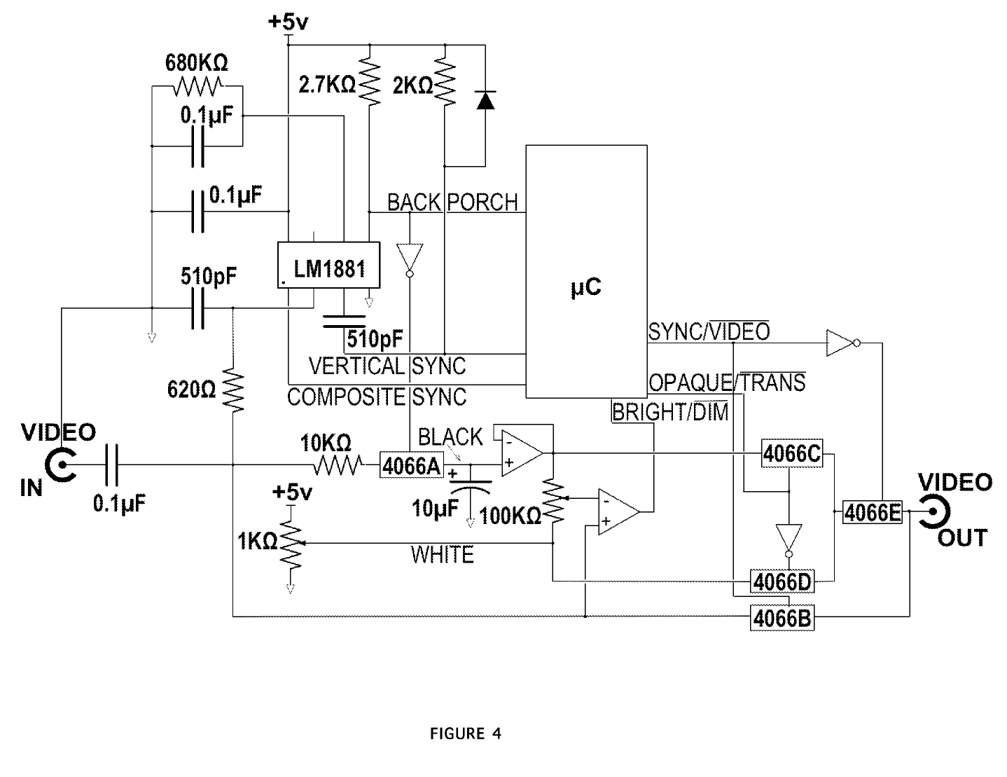

In addition to this pixel array, an imaging device (such as a video camera or, typically, a black and white video camera) is utilized to identify the light source or sources. The video from this imaging device is enhanced with an inverting threshold comparator circuit (as generally shown in FIG. 4) such that the video output is either low for black (where an area of the image source is above a brightness level set for the threshold comparator) or high for white or transparent (where an area of the image source is below the brightness level of the threshold comparator). When the video signal is high (i.e., brightness), the corresponding pixels of the pixel array will be dark and when the video output is low, the corresponding pixels of the pixel array will be transparent. (The video signal can alternatively be output from the inverting threshold comparator video circuit as an inverted, traditional composite video signal—such a signal could provide a grey scale image to set the pixel array pixels to intermediate levels thereby allowing very bright light sources to be blocked while allowing some light to pass from less bright sources.)

Referring to FIG. 4, an inverting threshold comparator video circuit is generally shown. A black and white video camera is mounted proximate to the top edge of the driver's side of the windshield pointing forward. An NTSC composite video output from the camera is connected to the VIDEO IN connection at the left side of the figure. The signal goes in three directions after passing through a 0.1 μF capacitor.

A first path passes through a 620 Ω resistor to pin 2 of an LM1881 Sync Separator (such as that manufactured by Texas Instruments). The LM1881 extracts synchronization information from the video signal and outputs signals for COMPOSITE SYNC (a low going pulse between scan lines), VERTICAL SYNC (a low going pulse to signal the end of a video frame) and BACK PORCH (a low going signal to indicate the portion of the horizontal scan line after the horizontal sync pulse and before the video image information—this back porch is at a voltage level corresponding to an image pixel that is black). These three signals are connected to three of the microcomputer's inputs.

A second path goes down to a transmission gate (4066B) whereby it can be passed to the VIDEO OUT connection. This path is to enable the microcomputer (pC) to control the passing of the sync signal portion of the video input signal through to the output (this transmission gate passes a signal when the SYNC/VIDEO output from the microcomputer is logic high). It also provides the raw video input signal to the comparator.

A third path passes through a 10 KΩ resistor through a transmission gate (4066A) to a 10 μF capacitor. The transmission gate is switched when the back porch signal is low (the inverter from BACK PORCH is to switch on during this period) so that the black voltage level is held on this capacitor as will be well understood by those versed in the art of sample and hold circuits. The resistor and capacitor values form a low pass filter that would remove a color burst signal superimposed upon the back porch black signal level if one were present. The black signal level is buffered by a non-inverting, unity gain op-amp. This black signal level is made available to a transmission gated path (4066C & 4066E) to the output and to a 100 KΩ potentiometer.

A 1 KO potentiometer is provided to adjust a voltage corresponding to an image pixel that is white. This signal level will result in a transparent pixel at the LCD display. This white signal level is made available to a transmission gated path (4066D & 4066E) to the output and to the 100 KΩ potentiometer. The 100 KΩ potentiometer can be adjusted to any voltage lever between the white voltage level and the black voltage level of the incoming video signal. Typically, this potentiometer will be adjusted to the level corresponding to the voltage level found in the input video signal when a light source is imaged that is brighter than the brightest light comfortably viewed. This voltage level adjustment is provided to the negative terminal of a high speed comparator (i.e., one that is suited to the higher frequencies of a video signal). The raw video input signal is connected to the plus input of the comparator such that when the input signal exceeds the threshold (i.e., a pixel is imaged by the camera that is brighter than the brightest desired light) the output of the comparator switches to a logic high level. This comparator output provides a serial binary signal to the BRIGHT/DIM input of the microcomputer. This bit stream is taken in by the microcomputer and buffered and is also output by the microcomputer on the OPAQUE/TRANS output (with some additional bit processing, further described below). The OPAQUE/TRANS output drives the transmission gates (4066C & 4066D) such that either the black video signal level or the white video signal level is provided to transmission gate (4066E). When the microcomputer detects that the video input signal is within the video portion of the signal (as opposed to the sync signals), it drives the SYNC/VIDEO signal low which results in either the black or the white video voltage level being passed to the VIDEO OUT connection.

The microcomputer runs a program to read the COMPOSITE SYNC, VERTICAL SYNC and BACK PORCH inputs to determine when the video signal is within the video portion of the signal or the sync signals as is very well understood by those skilled in the art of video signal processing and as is described in many documents (for example, the datasheet and application notes by Texas Instruments relating to the LM1881 video sync separator integrated circuit chip). Generally speaking, from the point when the VERTICAL SYNC signal goes low, the microcomputer counts horizontal scan lines with each low going pulse on the COMPOSITE SYNC input until the start of the video portion of the input signal is arrived at. From this point, the SYNC/VIDEO output is toggled to pass either the sync pulses from the input video signal (e.g., when COMPOSITE SYNC or BACK PORCH is low, SYNC/VIDEO is set HIGH) or the BLACK or WHITE voltage levels as dictated by the OPAQUE/TRANS signal from the internally buffered BRIGHT/DIM input bits when SYNC/VIDEO is set LOW. To be more precise, during the sync portion of the video signal, the microcomputer's internal bits buffer is cleared (all bits set to LOW corresponding to a dim light source); during the video portion of each horizontal scan line, the SYNC/VIDEO output is set to its LOW level and bits are read in sequentially on the BRIGHT/DIM input. As the BRIGHT/DIM input is sampled, (a) the bit value is placed into a buffer (the first bit is placed in location n and then n is incremented), and (b) a bit is read out from the buffer at location m and then m is incremented (where m=0 at the start of each horizontal scan line), and (c) the bit from step (a) is OR'd with the bit from step (b) and then output on the OPAQUE/TRANS output. If either bit is HIGH, a HIGH signal will be output on the OPAQUE/TRANS output. If the sampled bit is high (corresponding to a bright light source) the combination of the SYNC/VIDEO (LOW) and OPAQUE/TRANS (HIGH) outputs will cause an opaque pixel to be asserted in the corresponding location of the LCD visor display. If the sampled bit is low (corresponding to a dim light source) the combination of the SYNC/VIDEO (LOW) and OPAQUE/TRANS (LOW) outputs will cause a transparent pixel to be asserted in the corresponding location of the LCD visor display. The steps (a)-(b)-(c) repeat until the end of the video portion of the horizontal scan line. The purpose of the buffering and OR'ing of bits is such that every darkened area of the display will have a second ghost image n bits to the right of the original image. This facilitates an opaque pixel area for both eyes. (Note that if the original opaque pixel is sufficiently close to the right edge of the visor display, the corresponding ghost pixel will not occur before the end of the horizontal line scan and will not be displayed; this corresponds to the light source being visible to the right eye around the right edge of the display.)

The display (i.e., the pixel array) will display pixels as being either on or off corresponding to the high or low, respectfully, signal output from the inverting threshold comparator circuit. The duplicate ghost overlay image would be simultaneously displayed to account for a dark area in the pixel array corresponding to both eyes of the user (e.g., the user's left eye would have each point of bright light blocked by the original image, whereas this duplicate overlay image would provide dark pixels to block the user's right eye). This is accomplished by overlaying each horizontal scan line on top of itself with a slight delay such that a duplicate image would appear slightly to the right of the original image. The amount of slight delay would be adjustable to enable the user to adjust the spacing between the two overlaid images to correspond to the user's eye spacing. These techniques are well understood by those skilled in the art of video processing. If each eye has its own pixel display (as would be the case with an eyeglasses implementation), this duplicate overlay image feature would be excluded.

For example, consider a single point light source; this will be picked up by the video camera and received on the BRIGHT/DIM input. This bit will be output so as to cause an opaque pixel on the display and then a second opaque pixel n pixels to the right of the first opaque pixel. The driver will manually reposition the visor display (by moving it left or right) so as to cause the first opaque pixel to be positioned in line with the single point light source and the driver's left eye and, in so doing, will block the single point light source from being viewed by the driver's left eye. By properly positioning the second opaque pixel to the right of the first opaque pixel, that second opaque pixel will be positioned in line with the single point light source and the driver's right eye and, in so doing, will block the single point light source from being viewed by the driver's right eye as well. While it is clear that a driver could manually reposition the visor display (by moving it left or right) to position the opaque pixel for the left eye, it is by setting the value of n that the ghost pixel is positioned for the right eye. An easy way to do this is to connect the wiper connection of a potentiometer to an input equipped with an analog-to-digital converter (ADC) with its two resistor ends going to +5v and ground, respectively. The microcomputer would read the value for n directly from the ADC (e.g., a value of 0 to 255). In this way, the driver would identify a bright light source and position the visor display by moving it left or right (with his or her right eye closed) to block that bright light source to the left eye; then (with the right eye now opened and the left eye closed) would adjust this potentiometer to block that same bright light source to the right eye.

The pixel array is controlled much as a traditional composite video display to display the output of the inverting threshold comparator circuit. However, certain additional image control features could be included for the best user experience. While all or some of these control features are not required, when included, these image control features include one or more of the control features of horizontal image shifting, vertical image shifting, and image zoom. Control signals can be provided for each control feature when included and these control signals can be input manually by the user (e.g., using input devices such as a knob or wheel or via other input means such as a touch screen or the like as are well known to those skilled in the art) or they can be generated by secondary systems that automatically determine the best control settings and then provide these control signals. Image control features can be implemented in analog or digital circuits or software. The specific implementations will be well understood by those skilled in the art of digital video processing.

The horizontal control signal shifts to the left or right where the pixels are displayed on the display (i.e., the pixel array). Rather than rely on manually positioning the visor display, this could alternatively be done by taking the horizontal scan image (e.g., from the composite video output from the inverting threshold comparator circuit) and discarding zero or more of the pixels at the beginning of each horizontal scan line (i.e., by freezing the horizontal position on the pixel array until a point after the start of each horizontal scan line in the composite video input; put another way, add bits to the buffer at position m-x and read bits from the buffer at position n-x where x is a user settable value). Likewise, the image can be shifted in the opposite direction by beginning the displaying of each horizontal scan line at a point to the right of the left edge of the display (e.g., add bits to the buffer at position m+x and read bits from the buffer at position n+x). In either case, any portion of the display (at the left edge or at the right edge of the pixel array) for which there is no corresponding composite video scan line available would display as transparent. This horizontal adjustment will allow the user to position the dark pixels in line with the bright light source or sources in the left-to-right direction. These techniques will be well understood by those skilled in the art of video processing.

The vertical signal works in a similar way by starting the displayed image at the top edge of the display on other than the first horizontal scan line of the video output from inverting threshold comparator circuit. If the first displayed line is one that is after the first horizontal scan line of the video output from the inverting threshold comparator circuit, the dark pixels on the display (i.e., the pixel array) will be shifted upward. If the first displayed line is before the first horizontal scan line of the video output from inverting threshold comparator circuit (i.e., one or more blank lines are displayed before the first horizontal scan line of the video output from the inverting threshold comparator circuit), the dark pixels on the display (i.e., the pixel array) will be shifted downward. In either case, any portion of the display for which there is no corresponding composite video scan line available (at the top or at the bottom of the pixel array) would display as transparent. This vertical adjustment will allow the user to position the dark pixels in line with the bright light source or sources in the up-to-down direction. (One way to accomplish this within the context of the above example would be to adjust the number of low going pulses on the COMPOSITE SYNC input counted from the point when the VERTICAL SYNC signal goes low for determining when the start of the video portion of the input signal is arrived at.) These techniques will likewise be well understood by those skilled in the art of video processing.

The zoom signal enables multiple light sources to all be blocked correctly to the user's left eye (the right eye would be blocked by the duplicate overlay image, as described above). For example, if a bright light at the left side of the user's view is blocked by dark pixels at the left side of the pixel display, but a bright light source at the right side of the user's view are not blocked by dark pixels on the right side of the pixel array because those dark pixels are too far to the left, zooming the image out (i.e., zooming or scaling to make the image larger) will adjust the spacing between the left and right side of the screen. Likewise, if a bright light at the left side of the user's view is blocked by dark pixels at the left side of the pixel display, but a bright light source at the right side of the user's view are not blocked by dark pixels on the right side of the pixel array because those dark pixels are too far to the right, zooming the image out (i.e., zooming or scaling to make the image smaller) will adjust the spacing between the left and right side of the screen. A simple way that this can be adjusted is to having an adjustable lens on the video camera for zooming. However, digital imaging processing techniques can be used that are well understood by those skilled in the art of video processing.

Further video image processing could be incorporated that would enlarge the dark pixel areas on the display by shifting the image slightly to the left (as is done in the horizontal signal, described above) on the pixel display and then keeping the pixels dark for a short duration after the image changes to transparent (on each horizontal scan line). This will cause the dark area or areas to be slightly wider than the actual light source or sources being blocked, thereby allowing the user to have a bit of left to right margin in blocking the bright light source or sources. Similar signal processing could be employed to provide some vertical margin in blocking the bright light source or sources. (This stretching of opaque pixels can be accomplished in the context of the above example by outputting one or more opaque pixels whenever the output would otherwise change from opaque to transparent). These techniques are well understood by those skilled in the art of video processing.

A variation would be to include facial recognition to locate the position of the user's face and adjust the vertical, horizontal and zoom automatically. This would be done by adding a second imaging device directed towards the user to identify the position of the user with facial feature recognition as is well known to those skilled in the art of facial recognition image processing. In this way, if the user shifts to the left or right, the horizontal adjustment can be made automatically to move the threshold image left or right to keep the dark pixels in line between the user's eyes and the corresponding light source or sources. If the user shifts his or her position up or down, the vertical adjustment can be made automatically to move the threshold image up or down to keep the dark pixels in line between the user's eyes and the corresponding light source or sources. If the user shifts forward or back, the zoom adjustment can be made automatically to shrink or enlarge, respectively, the threshold image to keep the size of the dark pixels corresponding to the area of the light source or sources in the image.

Another variation would be to incorporate gray shading such that very bright light sources are completely blocked by fully dark pixels whereas somewhat bright light sources could be blocked by opaque pixels. This could be accomplished by replacing the inverting threshold comparator circuit with a video circuit that provides a photo-negative (i.e., inverted pixels) image and an LCD display that can render a quality gray-scaled image.

The foregoing description of an example of the preferred embodiment of the invention and the variations thereon have been presented for the purposes of illustration and description. It is not intended to be exhaustive or to limit the invention to the precise forms disclosed. Many modifications and variations are possible in light of the above teaching. It is intended that the scope of the invention be limited not by this detailed description.

I claim:

1. A method for blocking one or more bright light sources in a scene to the eyes of a user comprising (i) sensing the position of one or more light sources, (ii) darkening pixels in a pixel array corresponding to the light sources sensed, and (iii) viewing the scene through the pixel array.

2. A device for blocking one or more bright light sources to the eyes of a user comprising a device for sensing the position of one or more light sources and a transparent surface comprising means to darken areas of said transparent surface corresponding to the positions of the light sources sensed.

3. The method of claim 1 further comprising duplicating one or more darkened pixels corresponding to the light sources sensed to block a light source to both eyes of the user.

4. The device of claim 2 further comprising means to duplicate one or more darkened pixels corresponding to the light sources sensed to block a light source to both eyes of the user.

5. The method of claim 1 further comprising shifting the image horizontally.

6. The device of claim 2 further comprising means to shift the image horizontally.

7. The method of claim 1 further comprising shifting the image vertically.

8. The device of claim 2 further comprising means to shift the image vertically.

9. The method of claim 1 further comprising scaling the image.

10. The device of claim 2 further comprising means to scale the image.

11. The device of claim 2 whereby the transparent surface is comprised by an eyeglasses lens.

12. The device of claim 2 whereby the transparent surface is comprised in a mirror.

13. The mirror of claim 12 whereby the mirror is comprised by a vehicle.

14. The device of claim 2 whereby the transparent surface is comprised by a windshield or a windscreen of one of a car, a boat, an airplane, a motorcycle, a snowmobile or a vehicle.

15. The method of claim 1 further comprising providing inputting a value to adjust a parameter.

16. The method of claim 15 whereby the value to adjust a parameter is used for one or more of shifting the image horizontally or vertically, scaling the image, or stretching the pixel size.

17. The device of claim 2 further comprising means to input a value to the device.

18. The device of claim 17 whereby the value input to the device is used for one or more of shifting the image horizontally or vertically, scaling the image, or stretching the pixel size.

19. The method of claim 15 whereby inputting is accomplished by an imaging device that can recognize facial features.

20. The device of claim 17 whereby inputting is accomplished by an imaging device that can recognize facial features.
